(19) United States
(12) Patent Application Publication
(10) Pub. No.: US 2023/0185752 A1
(43) Pub. Date: Jun. 15, 2023

(54) UNIVERSAL SERIAL BUS (USB) CABLE WITH INTEGRATED SWITCH FOR CHANGING FUNCTIONAL MODES

(71) Applicant: Osom Products, Inc., Palo Alto, CA (US)

(72) Inventors: Jason Sean GAGNE-KEATS, Cupertino, CA (US); David Evans, Portola Valley, CA (US); James Kim, San Jose, CA (US); Evan Jackson, San Jose, CA (US); Nick Franco, San Jose, CA (US)

(21) Appl. No.: 17/549,488

(22) Filed: Dec. 13, 2021

(51) Int. Cl. G06F 13/40; H01R 13/70; G06F 1/26

(52) U.S. Cl. CPC G06F 13/4027; H01R 13/70; G06F 1/266; H01R 24/60

(57) ABSTRACT

A Universal Serial Bus (USB) cable includes a connector and a switch. The connector includes a housing configured for gripping by a user to manually insert/remove the connector to/from a port of an electronic device. The connector includes a power line configured to enable transfer of power to the electronic device and a data line configured to enable exchange of data with the electronic device. The switch is integrated into the outer surface of the housing and includes, for example, a toggle that is mechanically movable between a first position that activates a private mode and a second position that deactivates the private mode. The exchange of data with the electronic device is only enabled while the toggle is in the second position, and the transfer of power to the electronic device is enabled regardless of whether the toggle is in the first position or the second position.

### BACKGROUND

Universal Serial Bus (USB) is an industry standard that establishes specifications for cables, connectors, and protocols for connection, communication, and power supply between computers, peripherals, and other computers. Specifically, USB was designed to standardize the connection of peripherals to personal computers, both to communicate with and to supply electric power. USB has largely replaced interfaces such as serial ports and parallel ports and has become commonplace in a wide range of devices. Examples of devices that connect via USB include cameras, printers, media players, mobile phones, and network adapters. USB connectors have been increasingly replacing other types of charging ports for portable devices. In fact, a broad variety of USB hardware exists, including fourteen different connectors, of which USB-C is most recent.

USB was developed to simplify and improve the interface between personal computers and peripheral devices, when compared with previously existing standard or ad hoc proprietary interfaces. From the computer user's perspective, the USB interface improves ease of use in several ways. For example, the USB interface is self-configuring, eliminating the need for the user to adjust the device's settings for speed or data format, or configure interrupts, input/output addresses, or direct memory access channels. USB connectors are standardized at the host, so any peripheral can use most available connectors. Further, USB takes full advantage of the additional processing power that can be economically put into peripheral devices so that they can manage themselves. As such, USB devices often do not have user-adjustable interface settings. The USB interface is hot-swappable (e.g., devices can be exchanged without rebooting the host computer). In addition, small electronic devices (e.g., mobile phones) can be powered directly from the USB interface, eliminating the need for additional power supply cables.

### BRIEF DESCRIPTION OF THE DRAWINGS

Detailed descriptions of implementations of the present invention will be described and explained through the use of the accompanying drawings.

FIG. 1 illustrates a Universal Serial Bus (USB) cable that implements aspects of the present technology.

FIG. 2 illustrates a connector including a pin structure of a standard USB Type-C connector.

FIG. 3A illustrates a top view of a USB cable including a connector with a privacy switch positioned to enable data communications.

FIG. 3B illustrates a top view of the USB cable of FIG. 3A with the privacy switch positioned to disable data communications.

FIG. 3C illustrates a side view of the USB cable of FIG. 3A.

FIG. 4 is a flowchart that illustrates a method for switching a USB cable between one mode that disables one function while another function remains enabled.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to incorporating a switch into a Universal Serial Bus (USB) cable. The USB cable can connect two electronic devices both to communicate data and to supply electric power. Examples of electronic devices include a personal computer connected to a peripheral device such as a computer keyboard, mouse, camera, printer, portable media player, mobile phone, and network adapter. The switch integrated into the USB cable can be toggled between at least two states to activate or deactivate modes that enable or disable selected functions. For example, mechanically actuating the switch can set the USB cable to a private mode that disables data communication between the electronic devices.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

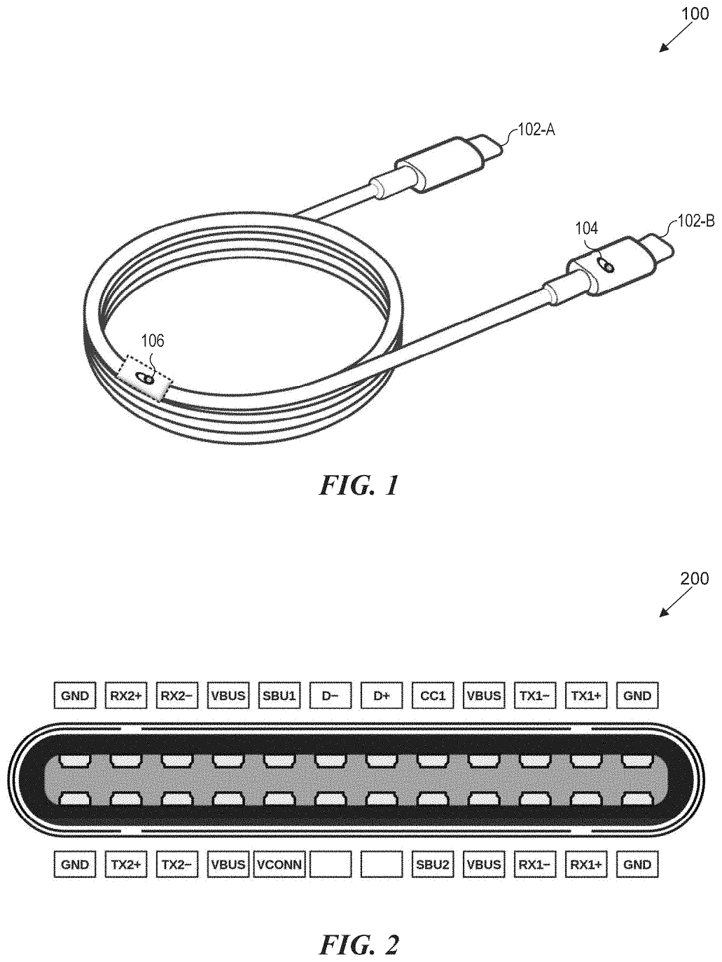

FIG. 1 illustrates a USB cable that can implement aspects of the present technology. As shown, the USB cable 100 (“cable 100”) includes two connectors 102-A and 102-B (also referred to as “plugs”) that can plug into receptacles (also referred to as “sockets”) of electronic devices to exchange data over one or more data lines and/or transfer power over one or more power lines. The cable 100 of the illustrated example is a standard USB-C cable that is usually included in-box with consumer devices but additionally includes a switch 104 that enables a user to physically disable/enable a function (e.g., data exchange) on demand, while maintaining another function (e.g., for rapid charging) operational. The switch 104 can be incorporated into a housing of any type of USB cable or other data cable that has additional functions (e.g., power charging).

As shown, the switch 104 is incorporated only into the connector 102-B and not connector 102-A or is optionally incorporated in another housing located elsewhere on the cable 100 (e.g., switch 106). In fact, a switch can be located anywhere that includes the data lines and/or power lines of the cable 100. In another example, a switch is incorporated into each connector at both ends of the cable 100 (not shown). The switch 104 is described herein without certain details of a typical design and operation of any internal circuitry of switches or USB cables or connections that are well known. In one example, the switch 104 gives users the ability to activate a private mode that interrupts data lines between the electronic devices coupled to the connectors 102-A and 102-B of the cable 100. Activating or deactivating the private mode does not necessarily impede other functions including a fast charge function or other power delivery functions.

USB cables of different types (e.g., 2.x, 3.x, Type-C) can have different connectors that plug into different receptacles (e.g., different shapes and sizes). Moreover, different types of connectors can have different pin configurations. For example, FIG. 2 illustrates a standard USB Type-C connector with 24 pins. The pins include a set of D+ and D− pins for data communication of USB 2.0 connectivity. The V_{BUS} and GND pins are power and the return paths for signals. The default V_{BUS} voltage is 5 V but the USB standard allows devices to negotiate and choose a V_{BUS} voltage other than the default value. The power delivery allows V_{BUS} to have a voltage up to 20 V. The maximum current could be raised up to 5 A. Hence, USB Type-C could deliver a maximum power of 100 W. The high-power flow could be useful when charging a large device such as a notebook computer. The power delivery technology makes USB Type-C more versatile than older standards because the power level is adaptable with the needs of a load. As such, a user can charge both a smartphone and notebook using the same cable.

The connector 200 includes two sets of RX pairs and two sets of TX pairs. One RX pair along with one TX pair could be used for the USB 3.x protocol. A USB Type-C port could support USB 3.x standards but the minimum feature set of USB Type-C does not include USB 3.x. In such cases, the RX/TX pairs are not used by the USB 3.x. connectivity and could be used for other USB Type-C functionalities.

The CC1 and CC2 pins are channel configuration pins that perform a number of functions such as cable attachment and removal detection, connector/plug orientation detection, and current advertisement. These pins could also be used for the communications required by the power delivery and alternate mode. Some active cables utilize a re-driver chip to strengthen the signal and compensate for the losses incurred by the cable. In these cases, the circuitry can be powered inside the cable by applying a 5-V, 1-W power supply to the VCONN pin. The SBU1 and SBU2 pins correspond to low-speed signal paths that are used only in an alternate mode.

The data connection for the cable 100 is only required to meet USB 2.0 speeds, and thus the SuperSpeed lines for USB 3.x can be ignored for simplicity. Examples of active pin connections in private and non-private modes are illustrated below as tables where each cell represents a pin. The shaded cells represent pins that could operate the same under private and non-private modes or have functions that are irrelevant to those modes.

As shown above, in non-private mode, the D+ and D− pins are enabled to provide USB 2.0 connectivity (e.g., uninterrupted data). On the other hand, in private mode, the D+ and D− pins are disabled (e.g., interrupted, blocked) to disallow USB 2.0 connectivity. The VBUS and GND pins remain functional regardless of whether the cable is in private or non-private modes.

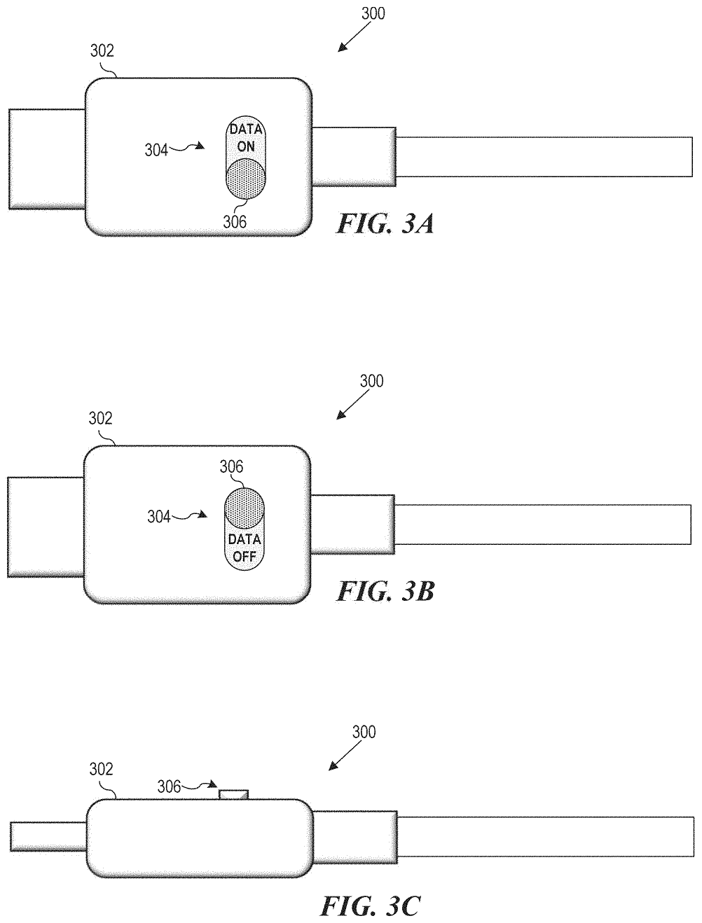

FIGS. 3A through 3C are illustrations of an end portion 300 of a USB cable that includes a connector 302 integrating a switch 304 having a toggle 306 that can be switched between two alternative positions to activate or deactivate different modes. Specifically, FIG. 3A illustrates a top view of the end portion 300 including the toggle 306 of the switch 304 in a first position that activates a non-private mode and deactivates a private mode. As such, the cable enables data transfers between two devices that are coupled via the cable. FIG. 3B illustrates a top view of the end portion 300 including toggle 306 of the switch 304 in a second position that activates the private mode and deactivates the non-private mode. As such, the USB cable disables data transfers between two devices that are coupled to respective ends of the USB cable. Lastly, FIG. 3C illustrates a side view of the end portion 300 including the toggle 306 protruding above the surface of the connector 302.

The connector 302 includes a housing having an outer surface configured for gripping by a user to manually insert or remove the connector to or from a receptacle of an electronic device. The connector 302 also includes data and power lines (not shown) inside the housing and coupled to respective pins that can electrically contact counterpart pins on the receptacle of the electronic device. For example, a power line inside the housing can transfer power to the electronic device and data lines inside the housing can exchange data between the electronic device and another electronic device.

The switch 304 is integrated into the outer surface of the housing and includes the toggle 306, which protrudes from the outer surface. The toggle 306 is mechanically movable between a first position that activates a first mode (e.g., a private mode) and a second position that deactivates that mode and/or activates a different mode. For example, a data line can be enabled to allow exchanging data with the electronic device only while the toggle 306 is in the first position, while the power line is enabled to allow transferring power to the electronic device regardless of whether the toggle is in the first position or the second position. In one example, the switch 304 is configured to interrupt the data line when the toggle 306 is moved from the second position to the first position, and the switch 304 is configured to restore the data line when the toggle 306 is moved from the first position to the second position.

As shown, the switch 304 is a slider or toggle type, enabling a user to readily see the active mode of a cable. A toggle switch is a suitable type of electronic switch because it provides a binary on-off control to physically interrupt a data/power line or allow it to resume. In one example, the switch can remove a metal contact from a data/power line or bring the two back into contact. When the contact is connected, the circuit is closed and data/power can flow between attached electronic devices. Then when the contact is moved away again, the data/power flow is interrupted and the circuit becomes open, and the electronic devices cannot transfer data/power. The toggle of a switch is manually operated, to move from one position to another. In each position, the toggle can latch into place and remain there until moved back. The toggle will normally remain in position until manually moved once more, although momentary switches also include an attached spring which will pull the actuator back to its starting point once released.

When integrated in the connector 302, the switch 304 can be oriented to prevent inadvertently switching between the first mode and the second mode when the connector is plugged into or unplugged from the port of the electronic device. In the illustrated example, the switch 304 is oriented orthogonal to an axis in which the connector is configured to plug into the port of the electronic device. Further, the toggle 306 is movable orthogonal to the axis between the first position and the second position. In another example, a switch can be oriented so that plugging in the connector to a receptacle will cause activation of a private mode. For example, a switch can be oriented parallel to an axis in which the connector is configured to plug into the receptacle of the electronic device where the toggle is movable in parallel to the axis between a position that activates a private mode and a position that activates a non-private mode. When plugging into the receptacle, the position of the switch that activates the private mode is closer to the receptacle compared to the position that deactivates the private mode. As such, the force used to push the connector into the receptacle can also cause moving the switch into the position for activating the private mode.

A USB cable can include human perceptible indications that the cable is in one of multiple modes. In one example, an indication that the USB cable is in a private mode is made visible only when the toggle of the switch is in a position that activates the private mode and not visible when the toggle is in another position that activates a non-private mode. A different indication is visible only when the toggle is in the other position that activates the non-private mode and not visible otherwise. The indication can include a combination of color, iconography, text, etc. For example, a Light Emitting Diode (LED) next to the switch can emit different colors and/or patterns of lights depending on whether the USB cable is in a private mode or a non-private mode.

In the illustrated example, the indications include different text that are printed on the switch and which are alternatively revealed depending on whether the switch is in a first position or a second position. As such, the switch 304 is marked to enable the user to readily identify an active mode of operation. Specifically, when the toggle 306 is mechanically positioned to allow data transfers, a “Data On” message that is printed on the switch 304 is revealed while a “Data Off” message is hidden. On the other hand, when the toggle 306 is mechanically positioned to disable data transfers, the “Data Off” message that is printed on the switch 304 is mechanically revealed while the “Data On” message is hidden.

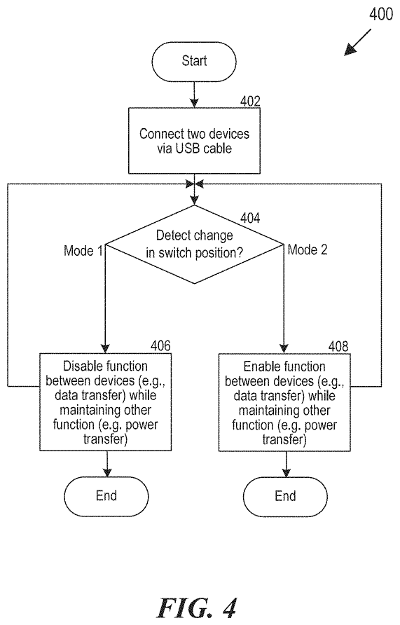

FIG. 4 is a flowchart that illustrates a method for switching a USB cable between one of two modes that disables one function while another function remains enabled. The method is performed at the USB cable and caused by a switch being changed between at least two positions. As described earlier, the switch can include a toggle and is integrated in a connector of the USB cable or elsewhere on the USB cable, such as another structure elsewhere at the USB cable.

At 402, connectors at the ends of the USB cable are plugged into the receptacles of two electronic devices. For example, a connector of a Type-C USB cable can be plugged into the receptacle of a laptop and the other connector can be plugged into a receptacle of a mobile phone. Doing so causes self-configuration of data communications over the USB cable between the two electronic devices. For example, data communication over the USB cable is enabled for the mobile phone to upload data to the laptop computer and/or download data from the laptop computer. In addition, the USB cable enables the laptop to transfer power to charge the battery of the mobile phone. As such, the USB cable provides both functions to exchange data and transfer power.

At 404, a change in a position of the switch is actuated. When integrated in the connector, the switch can be oriented orthogonal (e.g., perpendicular) to an axis in which the connector plugs into the receptacle of a first electronic device, to mitigate the risk that a user accidently switches the USB cable to an undesired mode when plugging or unplugging from the connector. Instead, switching the USB cable between modes requires movement of the toggle in the orthogonal direction between two positions for different modes. In another example, the switch is oriented along the same axis in which the connector plugs into a receptacle of the electronic device. As such, the toggle is movable along the same axis to switch the USB cable between different modes. In this example, moving the toggle to a location closer to the receptacle as the connector is being plugged into the receptacle of the electronic device can cause the USB cable to activate a private mode by default.

At 406, in response to the switch being in a first position, a first mode is activated, which disables a first function of the USB cable while a second function remains enabled. In one example, the first mode is a private mode, the first function is a data communication function, and the second function is a power transfer function. As such, a user can disable the data communication function while the power transfer function remains enabled. In another example, the first mode is a power mode, the first function is a power transfer function, and the second function is a data communication function. As such, a user can enable the power transfer function while the data communication function remains enabled. In addition, the USB cable can be caused to display a first indication that the first mode is activated.

At 408, in response to the switch being in the second position, a second mode is activated, which enables the first function of the USB cable while the second function remains enabled. In one example, the second mode is a non-private mode where the user enables the data communication function while the power transfer function remains enabled. In another example, the second mode is a non-power mode where the user can disable the power transfer function while the data communication function remains enabled. In addition, the USB cable can be caused to display a second indication, different from the first indication, that the second mode is activated.

Computer System

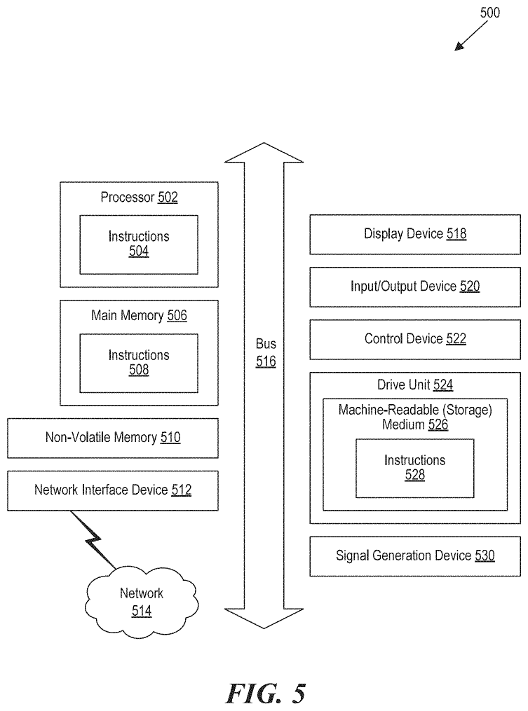

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A Universal Serial Bus (USB) cable comprising:
a first connector configured to connect to a first receptacle of an electronic device;
a second connector configured to connect to a second receptacle of a host device and including:
a housing having an outer surface configured for gripping by a user to manually insert or remove the second connector to or from the second receptacle of the host device;
one or more channel configuration pins, configured to receive a signal from the electronic device for indicating a level of power transmission;
V_{BUS} and GND pins configured to enable transfer of power to perform rapid charging of the electronic device, wherein a level of power transferred is based on the signal received by the one or more channel configuration pins; and
D+ and D− pins configured to enable exchange of data between the host device and the electronic device; and
a switch integrated into the outer surface of the housing and including:
a toggle that is mechanically movable to:
a first position that activates a non-private mode and deactivates a private mode,
wherein the first position of the toggle physically allows the D+ and D− pins to exchange data between the host device and the electronic device; and
a second position that deactivates the non-private mode and activates the private mode, wherein the second position of the toggle physically interrupts the D+ and D− pins to disallow exchange of data between the host device and the electronic device,
wherein the V_{BUS} and GND pins allow rapid charging of the electronic device regardless of whether the toggle is in the first position or the second position, and
wherein the switch has an orientation relative to a longitudinal axis of the first connector or includes a momentary mechanism to mechanically set the private mode as a default mode in response to the user manually inserting or removing the first connector to or from the second receptacle of the host device.

2. The USB cable of claim 1:
wherein the switch is configured to interrupt the D+ and D− pins when the toggle is moved to activate the private mode, and wherein the switch is configured to restore the D+ and D− pins when the toggle is moved to activate the non-private mode.

3. The USB cable of claim 1, wherein the toggle protrudes from the outer surface of the housing.

4. The USB cable of claim 1:
wherein the switch is oriented orthogonal to an axis in which the second connector is configured to plug into the first receptacle of the electronic device, and
wherein the toggle is movable orthogonal to the axis between the first position and the second position.

5. The USB cable of claim 1:
wherein the switch is oriented parallel to an axis in which the second connector is configured to plug into the first receptacle of the electronic device, and
wherein the toggle is movable parallel to the axis between the first position and the second position.

6. The USB cable of claim 1, wherein the switch is oriented to prevent switching between the private mode and the non-private mode when the second connector is plugged into or unplugged from the first receptacle of the electronic device.

7. The USB cable of claim 1, wherein the second connector further comprises:
a first visual indication that the USB cable is in the private mode,
wherein the first visual indication is visible only when the toggle activates the non-private mode and not visible when the toggle activates the private mode.

8. The USB cable of claim 7, wherein the second connector further comprises:
a second visual indication that the USB cable is in the non-private mode,
wherein the second visual indication is visible only when the toggle activates the private mode and not visible when the toggle activates the non-private mode.

9. The USB cable of claim 7, wherein the USB cable is a Type-C USB cable and only one connector has the switch configured to activate and deactivate the private mode.

10. A connection cable comprising:
a first connector and a second connector at each end of the connection cable,
wherein the first connector is configured to plug into a port of a first electronic device and the second connector is configured to plug into a port of a second electronic device;
one or more channel configuration pins, configured to receive a signal from the first electronic device for indicating a level of power transmission;
V_{BUS} and GND pins configured to enable transfer of power to perform rapid charging of a first electronic device using a second electronic device, wherein a level of power transferred is based on the signal received by the one or more channel configuration pins;
D+ and D− pins configured to enable exchange of data between the first electronic device and the second electronic device; and
a switch configured to set the connection cable in a private mode by default, wherein the switch includes a toggle that is mechanically movable to:
a first position that activates a non-private mode and deactivates a private mode,
wherein the first position of the toggle physically allows the D+ and D− pins to allow data exchange between the first electronic device and second electronic device; and
a second position that deactivates the non-private mode and activates the private mode, wherein the second position of the toggle physically interrupts the D+ and D− pins to disallow exchange of data between the first electronic device and the second electronic device,
wherein the V_{BUS} and GND pins allow rapid charging of the first electronic device regardless of whether the toggle is in the first position or the second position, and
wherein the switch has an orientation relative to a longitudinal axis of the first connector or includes a momentary mechanism to mechanically set the private mode as a default mode in response to manually inserting or removing the first connector to or from the port of the first electronic device.

11. The connection cable of claim 10, wherein the V_{BUS} and GND pins is enabled to allow power to transfer from the first electronic device to the second electronic device regardless of whether the connection cable is in the private mode or the non-private mode.

12. The connection cable of claim 10 further comprising:
a housing in which the switch is disposed on an outer surface, wherein the outer surface is configured for gripping by a user to manually insert or remove the second connector to or from the port of the first electronic device.

13. The connection cable of claim 10, wherein the switch is oriented orthogonal to an axis in which a first connector plugs into a first port of the first electronic device.

14. The connection cable of claim 10, wherein the switch is oriented along an axis in which a first connector plugs into a first port of the first electronic device.

15. A method for switching a Universal Serial Bus (USB) cable between one of two modes that disables one function while another function remains enabled, the method comprising:
configuring data communications over the USB cable between a first electronic device and a second electronic device coupled to a first connector and a second connector at each end of the USB cable using one or more channel configuration pins configured to receive a signal from the first electronic device for indicating a level of power transmission;
determining, based on the signal received by the one or more channel configuration pins, a level of power for transfer for performing rapid charging of the first electronic device using V_{BUS} and GND pins of the USB cable:
detecting a change in a position of a switch integrated in the USB cable wherein the switch is configured to set the USB cable in a private mode by default;
in response to the switch being changed to a first position, deactivating a private mode and activating a non-private mode, wherein the first position of the switch physically allows D+ and D− pins of the USB cable to exchange data; and
in response to the switch being changed to a second position, deactivating the non-private mode and activating the private mode, wherein the second position of the switch physically interrupts the D+ and D− pins to disallow exchange of data,
wherein the V_{BUS} and GND pins allow rapid charging regardless of whether the switch is in the first position or the second position, and
wherein the switch has an orientation relative to a longitudinal axis of the first connector or includes a momentary mechanism to mechanically set the private mode as a default mode in response to manually inserting or removing the first connector to or from a receptacle of the first electronic device.

16.-18. (canceled)

19. The method of claim 15:
wherein the switch is integrated in the first connector of the USB cable and oriented along an axis in which the first connector of the USB cable is configured to plug into the receptacle of the first electronic device,
wherein the first position is located closer to the receptacle when the first connector of the USB cable is plugged into the receptacle of the first electronic device compared to the second position.

20. The method of claim 15, further comprising:
causing display of a first visual indication in response to the switch being changed to activate the non-private mode; and
causing display of a second visual indication, different from the first visual indication, in response to the switch being changed to activate the private mode.
